(19) United States
(12) Patent Application Publication
(10) Pub. No.: US 2005/0263601 A1
(43) Pub. Date: Dec. 1, 2005

(54) Input apparatus having anti-slip mechanism for light pen

(75) Inventors: Katsuhito Iwasaki, Sagamihara-shi (JP); Hiroshi Nakamura, Minato-ku (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/133,673

(22) Filed: May 20, 2005

(30) Foreign Application Priority Data
May 28, 2004 (JP) 2004-158640

(51) Int. Cl. G06K 7/10

(52) U.S. Cl. 235/472.03

(57) ABSTRACT

As an anti-slip mechanism for a light pen whose tip is pressed against a light-emitting portion of the LED display unit to detect the position, a plurality of anti-slip members are arranged, above the light-emitting portions, at a surface panel of the LED display unit. The mechanism facilitates the positioning of the light pen to an intended light-emitting portion.

### BACKGROUND OF THE INVENTION

1. Field of the Invention

The present invention relates to an input device having an anti-slip mechanism for a light pen.

2. Description of the Related Art

In recent years, switching matrixes that change connections having a large number of relay switches have been used to flexibly switch connections between semiconductor-device characteristic measurement apparatuses and devices under test. In the switching matrixes, the relay switches are arranged in a matrix, and an LED (light- emitting diode) display unit in which a large number of LEDs are arranged so as to correspond to the respective relay switches is used to indicate whether the relay switches are in an open or closed state. For example, reference is made to the catalogue of Keithley Instruments Inc., “Keithley's Switching Systems for Switch and Control Solutions for DC, RF, and Light” , http://www.keithley.com/main.jsp?action=keithleysearch&searc hType=view&clickPath=Document+Center&itemType=brochure&role=&keywords=707, as found on May 17, 2004.

The LED display unit installed in the switching matrix is used together with a device called a light pen when an operator identifies the position of each relay switch. When operating the opening/closing of an arbitrary relay switch, the operator points the light pen against a target position among the LED matrix. In response, a large number of light-emitting portions in the LED matrix sequentially emit light for a very short period of time. Based on the timing at which a light-receiving portion provided at the light pen receives light from the light-emitting portions, the switching matrix identifies the position pointed at by the operator with the light pen. In this manner, the light pen has an input mechanism for identifying a position selected by the operator (e.g., refer to Japanese Unexamined Patent Application Publication No. 5-134806).

However, the surface of the known LED display unit is smooth and slippery, thereby making it difficult for the operator to stop the tip of the light pen at an intended light-emitting portion. Thus, the light pen may detect erroneous positional information. Accordingly, there is a problem in that the operator must carefully operate the light pen.

### SUMMARY OF THE INVENTION

The present invention has been made in view of the foregoing situation, and an object of the present invention is to provide an input apparatus that has a light pen anti-slip mechanism capable of improving the operability, that facilitates the positioning to an intended light-emitting portion, and that can ensure that the tip of the light pen is pressed against the intended light-emitting portion to appropriately detect the position.

To overcome the foregoing problem of the related art, the present invention provides an input apparatus having a light pen anti-slip mechanism. The input apparatus includes a display unit having a surface panel and a plurality of light-emitting portions, and a plurality of anti-slip members for the tip of a light pen disposed on the surface panel, and the anti-slip members are arranged so as to correspond to the respective light-emitting portions. In the present invention, protrusions, depressions, a lattice of ribs, stripe-shaped ribs, and through holes provided in an additional panel can be used for the anti-slip members. LEDs can be used for the light-emitting portions in the present invention.

In the present embodiment, placing the tip of the light pen onto the anti-slip mechanism can facilitate the positioning of the tip to an intended light-emitting portion in the display unit and can ensure that the tip of the light pen is pressed against the intended light-emitting portion to allow appropriate detection of the position, thus making it possible to improve the operability.

### BRIEF DESCRIPTION OF THE DRAWINGS

FIG. 1 is an exploded perspective view schematically showing a portion of a light pen anti-slip mechanism according to a first embodiment of the present invention;

FIG. 2 is a schematic view illustrating a process for fabricating the anti-slip mechanism shown in FIG. 1;

FIG. 3 is a schematic cross-sectional view of an anti-slip mechanism provided by the fabrication process shown in FIG. 2;

FIG. 4 is a schematic cross-sectional view of an anti-slip mechanism provided by a fabrication process that is different from the process shown in FIG. 2;

FIG. 5 is a cross-sectional view schematically showing a portion of an input apparatus having the light pen anti-slip mechanism according to a second embodiment of the present invention;

FIG. 6 is a schematic cross-sectional view of an anti-slip mechanism that is similar to the one shown in FIG. 5 and that is obtained by potting;

FIG. 7 is a schematic cross-sectional view showing a portion of an input apparatus having a light pen anti-slip mechanism according to a third embodiment of the present invention;

FIG. 8 is a perspective view schematically showing a portion of an input apparatus having a light pen anti-slip mechanism according to a fourth embodiment of the present invention;

FIGS. 9A and 9B are perspective views each schematically showing a portion of an input apparatus having a light pen anti-slip mechanism according to a fifth embodiment of the present invention;

FIG. 10 is an exploded perspective view schematically showing a portion of an input apparatus having a light pen anti-slip mechanism according to a sixth embodiment of the present invention;

FIG. 11 is a schematic cross-sectional view of the anti-slip mechanism shown in FIG. 10; and

FIG. 12 is a schematic cross-sectional view showing a portion of an input apparatus having a light pen anti-slip mechanism according to a modification of the embodiments of the present invention.

### DESCRIPTION OF THE PREFERRED EMBODIMENTS

An anti-slip mechanism for a light pen for an input apparatus according to the present invention will be described below with reference to the accompanying drawings.

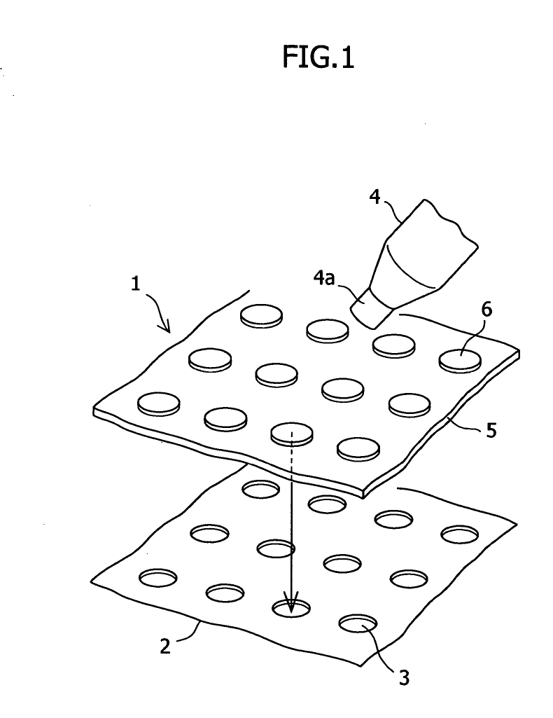

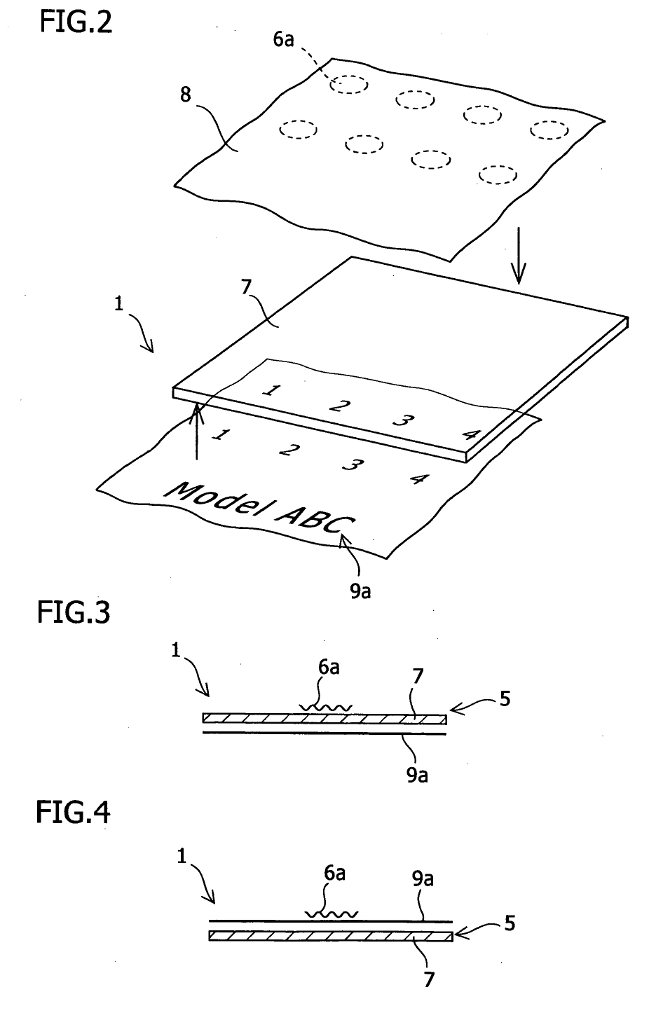

FIG. 1 is an exploded perspective view schematically showing a portion of a light pen anti-slip mechanism according to a first embodiment of the present invention. FIG. 2 is a schematic view illustrating a fabrication process for the anti-slip mechanism shown in FIG. 1. FIG. 3 is a schematic cross-sectional view of an anti-slip mechanism provided by the fabrication process illustrated in FIG. 2. FIG. 4 is a schematic cross-sectional view of an anti-slip mechanism provided by a fabrication process different from that illustrated in FIG. 2.

As shown in FIG. 1, a light pen anti-slip mechanism 1 according to the first embodiment of the present invention is applied to a light pen 4 and light-emitting portions 3 of an LED (light-emitting diode) display unit 2 incorporated in various types of computer. The anti-slip mechanism 1 has a plurality of anti-slip members 6, which are provided on a surface panel 5 of the LED display unit 2 by printing. In order to detect the position of character or graphic information displayed on the LED display unit 2, the light pen 4 is designed such that a tip 4a of the light pen 4 is pressed against an intended light-emitting portion 3 with the corresponding anti-slip member 6 interposed therebetween.

The light-emitting portions 3 of the LED display unit 2 may be arranged in a matrix at regular intervals in two mutually-perpendicular directions. In such a case, the anti-slip members 6 are arranged at regular intervals, only above the light-emitting portions 3 of the LED display unit 2, along two mutually-perpendicular directions of the surface panel 5 so as to correspond to the locations of the light-emitting portions 3. Moreover, each anti-slip member 6 is formed to have a circular shape (or a square shape or the like) having a diameter equal to or somewhat larger than the outer diameter of the tip 4a of the light pen 4.

In addition, the anti-slip members 6 are formed to be transparent by elastomeric printing. The elastomeric printing does not involve a special printing method. Thus, the anti-slip functions of the present invention can easily be added and removed. As shown in FIGS. 2 to 4, the present embodiment of the present invention uses a transparent base 7 (made of, for example, polycarbonate), which forms the surface panel 5 of the LED display unit 2, and an elastomer printing plate 8, on which an elastomer material 6a is printed. The elastomer material 6a provides the anti-slip members 6 and has large friction. The present embodiment can also use a silk printing plate with which, for example, characters and/or graphics 9a are printed.

In the present invention, the light pen 4 has an internal light-receiving portion in the tip 4a and it detects one light from the light-emitting portions 3 of the LED display unit 2 when the tip 4a is pressed against the surface of the light-emitting portions 4. Each of the light-emitting portions 3 emits light in a timing slightly shifted sequentially one after another. Based on the timing at which the light is received, the light pen 4 detects which of the light-emitting portions 3 is pointed at. For this purpose, the tip 4a of the light pen 4 includes a cylindrical switch having a light-receiving portion therein. With the switch being pressed, the light pen 4 can determine whether or not the light-receiving portion is receiving light. Although the light pen 4 has the light-receiving portion at the tip 4a in this case, the light pen 4 may have the switch on its main body portion so that the user operates the switch. In addition, although the light pen 4 has the light-receiving portion at the tip 4a, the switch may be provided at a position other than the light pen 4 (e.g., the main unit of the apparatus). Any device that can detect a position through pressing of the tip to the light-emitting portion of the LED display unit 2 can be used.

In the printing process shown in FIGS. 2 and 3, the elastomer printing plate 8 is used to transfer the elastomer material 6a to the top surface of the base 7 and the silk printing plate is used to transfer, for example, the characters and/or graphics 9a to the bottom surface of the base 7, thereby fabricating the anti-slip mechanism 1. In the printing process shown in FIG. 4, the silk printing plate is used to transfer, for example, the characters and/or graphics 9a to the top surface of the base 7 and the elastomer printing plate 8 is used to transfer the elastomer material 6a to the top surface of the characters and/or graphics 9a transferred by the silk printing plate, thereby fabricating the anti-slip mechanism 1. In FIGS. 3 and 4, for description of the structure, the characters and/or graphics 9a and the elastomer material 6a, which are transferred by the silk printing plate, are illustrated as being located away from the base 7. In practice, however, the characters and/or graphics 9a and the elastomer material 6a are printed in close contact with the base 7.

With the LED display unit 2 having the anti-slip mechanism 1 according to the first embodiment of the present invention, when the tip 4a of the light pen 4 is pressed against the anti-slip member 6 corresponding to an intended light-emitting portion 3, the tip 4a stops at that position without slipping. In this state, the position of the intended light-emitting portion 3 can be detected. Regarding the surface panel 5, surface portions other than the locations of the anti-slip members 6 are slippery. Thus, it is still possible to slide the tip 4a of the light pen 4 on the surface of the surface panel 5 to an intended light-emitting portion 3, and it can also be expected that the operability of the light pen 4 is improved.

That is, in the present embodiment, locating the tip 4a of the light pen 4 onto the anti-slip mechanism 1 can facilitate the positioning of the tip 4a to an intended light-emitting portion 3 in the display unit 2 and can ensure that the tip 4a of the light pen 4 is pressed against the intended light-emitting portion 3 to allow appropriate detection of the position, thus making it possible to improve the operability. In addition, since the anti-slip member 1 is provided by printing, the surface panel 5 appears to be flat. This allows for a reduction in difference in appearance depending on the presence/absence of this function, allows for free selection of the range of application, the size, and the shape, and allows for easy addition of a feature, as in typical plate fabrication. As described above, the anti-slip member 6 is formed to be transparent by the elastomer printing. Thus, regarding the surface panel 5 of the LED display unit 2, the friction of portions other than portions corresponding to the light-emitting portions 3 is reduced to thereby make it easier for the tip 4a of the light pen 4 to slide, while the friction of the portions corresponding to the light-emitting portions 3 is increased to thereby make it difficult for the tip 4a of the light pen 4 to slip. As a result, the light pen 4 can be stopped at an appropriate position.

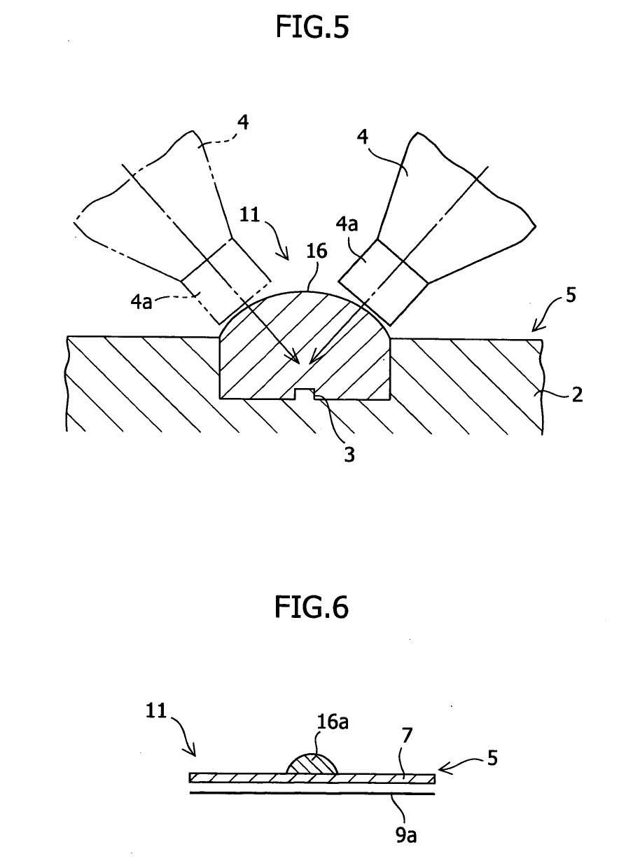

FIG. 5 is a cross-sectional view schematically showing a portion of a light pen anti-slip mechanism according to a second embodiment of the present invention. The same portions as those in the first embodiment are denoted with the same reference numerals and the descriptions thereof will not be given below. An anti-slip mechanism 11 according to the second embodiment of the present invention is different from that in the first embodiment in that, as shown in FIG. 5, the surface panel 5 of the LED display unit 2 has a plurality of protrusions 16. When the light-emitting portions 3 of the LED display unit 2 are arranged in a matrix at regular intervals in two mutually-perpendicular directions, the protrusions 16 are arranged at regular intervals, only at the light-emitting portions 3 of the LED display unit 2, along two mutually-perpendicular directions of the surface panel 5 so as to correspond to the locations of the light-emitting portions 3. Each protrusion 16 is formed so as to project in the shape of a dome having. a diameter somewhat larger than the outer diameter of the tip 4a of the light pen 4, thereby facilitating contact between the tip 4a of the light pen 4 and the protrusions 16.

The protrusions 16 are integrally formed on the surface panel 5 by pressing or molding that involves pouring or injecting a molten resin into a die cavity having depressions. In this case, the protrusions 16 can also be formed by using a light-transmitting resin for the upper portion of each light-emitting portion and shaping the surface of the resin into the protrusion form. This can also provide the surface panel 5 integrally formed on the transparent resin. Alternatively, as shown in FIG. 6, protrusions 16a may be formed by potting. The protrusions 16a are integrally formed on the surface panel 5 to have a spherical shape, which results from surface tension (viscosity), by dropping a potting compound containing an adhesive resin material (e.g., a polyurethane resin) onto the top surface of the base 7. The protrusions 16 have transparency so that light from the light-emitting portions 3 can exit. Other structures are similar to those of the first embodiment.

Thus, with the LED display unit 2 having the anti-slip mechanism 11 according to the second embodiment of the present invention, when the tip 4a of the light pen 4 is pressed against the protrusion 16 corresponding to an intended light-emitting portion 3, the light pen 4 contacts the outer circumferential surface of the protrusion 16 to stop at that position without slipping. In this state, the position of the intended light-emitting portion 3 can be detected. Furthermore, with the spherical-protrusion shape of each light-emitting portion 3 of the LED display unit 2, as indicated by the arrows in FIG. 5, when the tip 4a of the light pen 4 comes into contact with the protrusion 16 from any angle, the tip 4a is always directed to the center of the light-emitting portion 3. Consequently, the tip 4a can effectively receive light from the LED display unit 2, thereby making it possible to reduce detection error.

Thus, the present embodiment can facilitate directing the tip 4a of the light pen 4 toward the light-emitting portion 3 of the LED display unit 2, can make it difficult for the tip 4a of the light pen 4 to slip upon contacting the protrusion 16, and can ensure that the tip 4a of the light pen 4 is pressed against an intended light-emitting portion 16 of the LED display unit 2 to allow appropriate detection of the position. Moreover, with the spherical-protrusion shape of each light-emitting portion 3 of the LED display unit 2, when the tip 4a of the light pen 4 hits the protrusion 16 from any angle, the tip 4a is always directed to the center of the light-emitting portion 3. Consequently, the tip 4a can effectively receive light from the light-emitting portion 3, thereby making it possible to further reduce detection error. When pressing is used, it is possible to easily fabricate the light pen anti-slip mechanism at low cost. When the protrusion 16 is integrally formed to have a spherical shape by dropping a potting compound containing an adhesive resin material onto the surface panel 5, the spherical protrusion 16 can readily be provided by the surface tension of the potting compound, thereby making it possible to easily fabricate the light pen anti-slip mechanism at low cost. Other advantages are similar to those of the first embodiment.

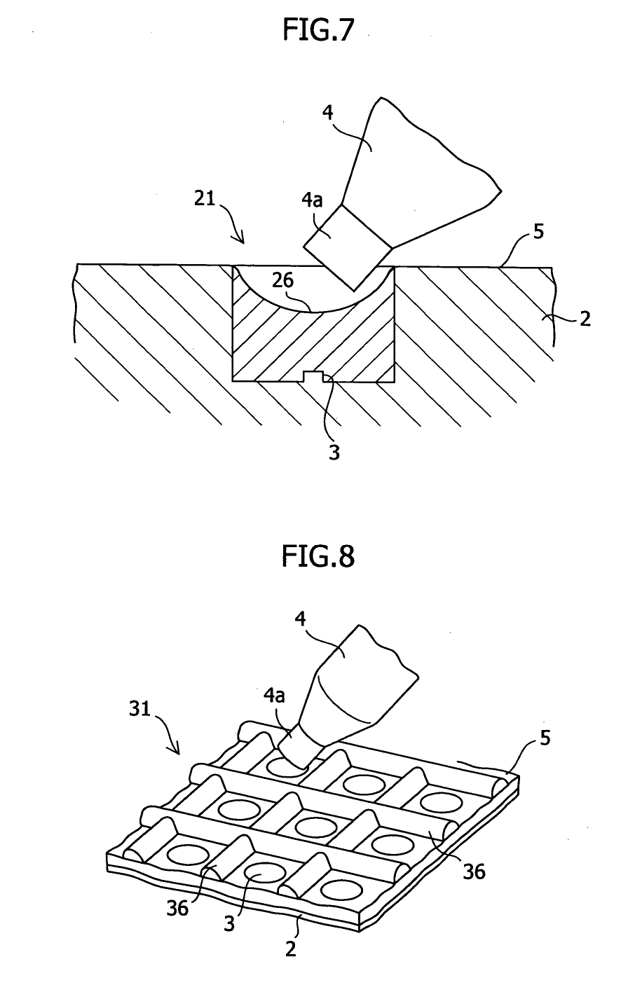

FIG. 7 is a cross-sectional view schematically showing a portion of a light pen anti-slip mechanism according to a third embodiment of the present invention. The same portions as those in the first embodiment are denoted with the same reference numerals and the descriptions thereof will not be given below. An anti-slip mechanism 21 according to the third embodiment of the present invention is different from that in the first embodiment in that, as shown in FIG. 7, the surface panel 5 of the LED display unit 2 has a plurality of depressions 26. When the light- emitting portions 3 of the LED display unit 2 are arranged in a matrix at regular intervals in two mutually-perpendicular directions, the depressions 26 are arranged at regular intervals, only above the light-emitting portions 3 of the LED display unit 2, along two mutually-perpendicular directions of the surface panel 5 so as to correspond to the locations of the light-emitting portions 3. Further, each depression 26 is formed so as to be depressed in the shape of a dome having a diameter somewhat larger than the outer diameter of the tip 4a of the light pen 4, thereby making it difficult for the tip 4a of the light pen 4 to escape from the light-emitting portion 3. The depressions 26 are integrally formed on the surface panel 5 by pressing. The depressions 26 are translucent so that light from the light-emitting portions 3 can exit. In this case, the depression 26 may also be formed by using a light-transmitting resin for the upper portion of each light-emitting portion 3 and shaping the surface of the resin into the depression form. This can also provide the surface panel 5 integrally formed on the transmitting resin. Other structures are similar to those of the first embodiment.

With the LED display unit 2 having the anti-slip mechanism 21 according to the third embodiment of the present invention, when the tip 4a of the light pen 4 enters the depression 26 corresponding to an intended light-emitting portion 3, the light pen 4 contacts the inner circumferential surface of the depression 26 to stop at that position without escaping from the light-emitting portion 3. In this state, the position of the intended light-emitting portion 3 can be detected. Other advantages are similar to those of the first embodiment.

FIG. 8 schematically shows a portion of a light pen anti-slip mechanism according to a fourth embodiment of the present invention. The same portions as those in the first embodiment are denoted with the same reference numerals and the descriptions thereof will not be given below. An anti- slip mechanism 31 according to the fourth embodiment of the present invention is different from that in the first embodiment in that, as shown in FIG. 8, the surface panel 5 of the LED display unit 2 has a lattice of ribs 36, which surround the corresponding light-emitting portions 3. When the light-emitting portions 3 of the LED display unit 2 are arranged in a matrix at regular intervals in two mutually-perpendicular directions, the ribs 36 are arranged at regular intervals, above the light-emitting portions 3 of the LED display unit 2, to extend linearly at regular intervals along two mutually-perpendicular directions of the surface panel 5 so as to correspond to the locations of the light-emitting portions 3. Further, each hollow surrounded by the ribs 36 is formed so as to have the shape of a square having a size somewhat larger than the outer diameter of the tip 4a of the light pen 4, thereby making it difficult for the tip 4a of the light pen 4 to escape from the light-emitting portion 3.

The ribs 36 are also integrally formed on the surface panel 5 so as to have a semicircular cross-section by pressing or molding that involves pouring or injecting a molten resin into a die cavity having depressions. Alternatively, in the same manner as the protrusions 16a of the first embodiment, which are formed by potting, the ribs 36 are integrally formed on the surface panel 5 to have a semicircular cross-section, which results from surface tension (viscosity), by dropping a potting compound containing an adhesive resin material (e.g., a polyurethane resin) onto the top surface of the base 7. Other structures are similar to those of the first embodiment.

Accordingly, with the LED display unit 2 having the anti-slip mechanism 31 of the fourth embodiment of the present invention, when the tip 4a of the light pen 4 enters the hollow surrounded by the ribs 36 corresponding to an intended light-emitting portion 3, the light pen 4 hits the outer circumferential surface(s) of the rib(s) 36 to stop at that position without escaping from the light-emitting portion 3. In this state, the position of the intended light-emitting portion 3 can be detected. This arrangement allows for appropriate detection of a position while ensuring that the tip of the light pen is pressed against an intended light-emitting portion of the LED display unit. Other advantages are similar to those of the first embodiment.

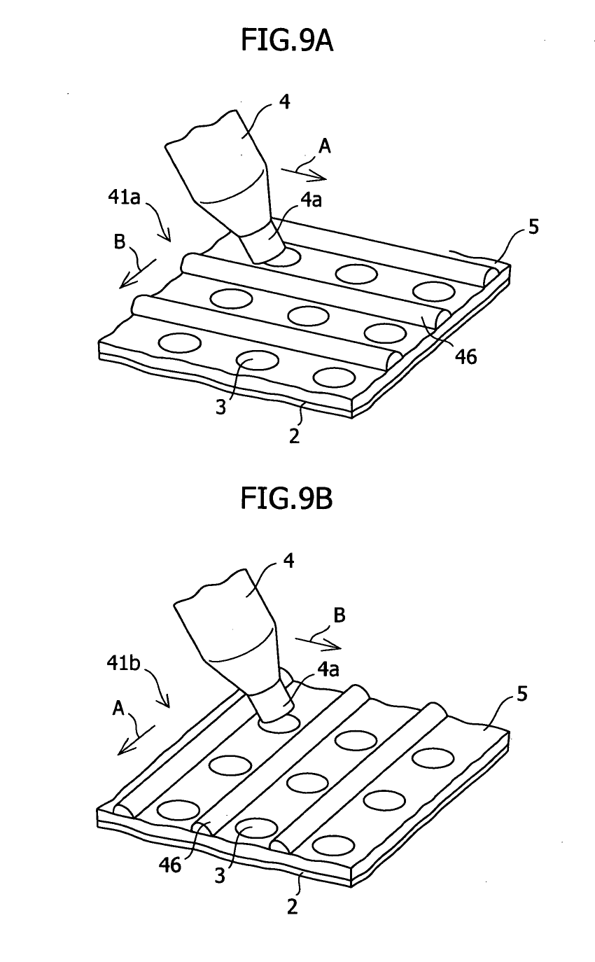

FIGS. 9A and 9B are views each schematically showing a portion of a light pen anti-slip mechanism according to a fifth embodiment of the present invention. The same portions as those in the fourth embodiment are denoted with the same reference numerals and the descriptions thereof will not be given below. Anti-slip mechanisms 41a and 41b according to the fifth embodiment of the present invention are different from the fourth embodiment in that, as shown in FIGS. 9A and 9B, the surface panel 5 of the LED display unit 2 has a plurality of stripe-shaped ribs 46 in either one of the two mutually-perpendicular directions. When the light-emitting portions 3 of the LED display unit 2 are arranged in a matrix at regular intervals in two-mutually perpendicular directions, the ribs 46 linearly extend at regular intervals along one of the columns and rows in the two-mutually perpendicular directions of the surface panel 5 so as to partition the light-emitting portions 3 in adjacent columns or rows. Each hollow surrounded by the ribs 46 is formed to have a band shape with a width somewhat larger than the outer diameter of the tip 4a of the light pen 4. Thus, the tip 4a of the light pen 4 can be smoothly slid, in a direction indicated by arrow A, in the same row to an intended light-emitting portion 3. On the other hand, with respect to movement across different rows of the light-emitting portions 3, the steps provided the ribs 46 makes the tip 4a of the light pen 4 difficult to move in a direction indicated by arrow B.

As in the fourth embodiment, the ribs 46 are integrally formed on the surface panel 5 so as to have a semicircular cross-section by pressing or molding that involves pouring or injecting a molten resin into a die cavity having depressions. Alternatively, in the same manner as the protrusions 16a of the first embodiment, which are formed by potting, the ribs 46 are integrally formed on the surface panel 5 to have a semicircular cross-section, which results from surface tension (viscosity), by dropping a potting compound containing an adhesive resin material (e.g., a polyurethane resin) onto the top surface of the base. Other structures are similar to those of the first embodiment.

Accordingly, with the LED display unit 2 having the anti-slip mechanism 41a or 41b of the fifth embodiment of the present invention, when the tip 4a of the light pen 4 is put in the hollow that is surrounded by the ribs 46 and that corresponds to an intended light-emitting portion 3 and is slid in one of the two mutually perpendicular directions, the light pen 4 can easily reach the intended light-emitting portion 3 in the same column or row. In addition, the light pen 4 hits the outer circumferential surfaces of the ribs 46, which serve as stoppers across different columns or rows, thereby allowing for the counting of the number of columns or rows and for speeding up the detection of the position of the light-emitting portion 3. Other advantages are similar to those of the first embodiment.

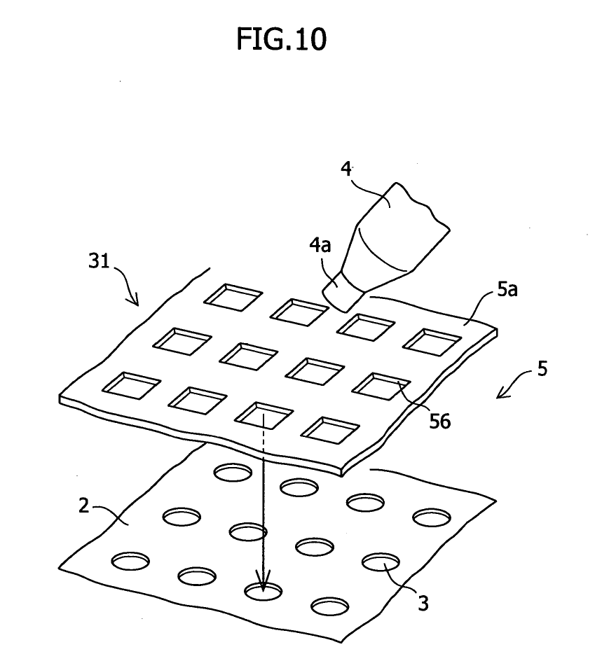

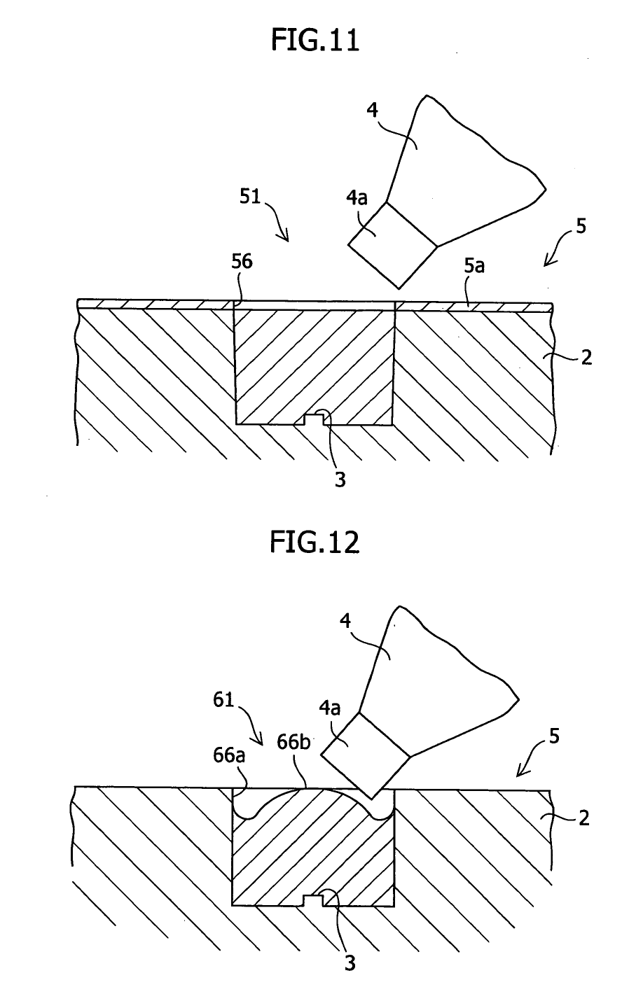

FIGS. 10 and 11 schematically show a portion of a light pen anti-slip mechanism according to a sixth embodiment of the present invention. The same portions as those in the first embodiment are denoted with the same reference numerals and the descriptions thereof will not be given below. An anti-slip mechanism 51 according to the sixth embodiment of the present invention is different from the first embodiment in that, as shown in FIGS. 10 and 11, an additional panel 5a having a plurality of through holes 56 is overlaid on the surface panel 5 of the LED display unit 2. Thus, when the light-emitting portions 3 of the LED display unit 2 are arranged in a matrix at regular intervals in two mutually-perpendicular directions, the through holes 56 are arranged at regular intervals, only above the light-emitting portions 3 of the LED display unit 2, along the two mutually-perpendicular directions of the surface panel 5 so as to correspond to the locations of the light-emitting portions 3. A light-transmitting resin is provided above the light-emitting portions 3 of the surface panel 5. The surface of the resin is shaped to be flat, so that the entire surface of the surface panel 5 is planarized. Also, the surface panel 5 can be integrally formed of a transparent resin. The through holes 56, provided in the additional panel 5a, are shaped to be a square having a size that is substantially the same as the outer diameter of the tip 4a of the light pen 4, thereby making it difficult for the tip 4a of the light pen 4 to escape from the light-emitting portion 3. The through holes 56 are provided by stamping through a pressing process or the like. Other structures are similar to those of the first embodiment.

Accordingly, with the LED display unit 2 having the anti-slip mechanism 51 according to the sixth embodiment of the present invention, when the tip 4a of the light pen 4 enters the through hole 56 corresponding to an intended light-emitting portion 3, the light pen 4 hits the inner edge(s) of the through hole 56 to stop at that position without escaping from the light-emitting portion 3. In this state, the position of the intended light-emitting portion 3 can be appropriately detected while the tip 4a of the light pen 4 is reliably pressed against the intended light-emitting portion 3. Other advantages are similar to those of the first embodiment.

While the embodiments of the present invention have been described above, the present invention is not limited thereto. Thus, various modifications, changes, and combinations are also possible without departing from the spirit and scope of the present invention. For example, the protrusions and depressions of the embodiments described above may be combined to provide an anti-slip mechanism 61 as shown in FIG. 12. This anti-slip mechanism 61 has a plurality of depressions 66a in the surface panel 5 of the LED display unit 2, and also has protrusions 66b within the respective depressions 66a to have a height that does not project from the top surface of the surface panel 5. The depressions 66a and the protrusions 66b are arranged above the light-emitting portions 3 of the LED display unit 2 at regular intervals in two mutually perpendicular directions of the surface panel 5 so as to correspond to the locations of the respective light-emitting portions 3 of the LED display unit 2. This arrangement, therefore, makes it easy to place the tip 4a of the light pen 4 at an intended light-emitting portion 3 and also makes it difficult for the tip 4a to escape from the light-emitting portion 3, due to the interaction of the depressions 66a and the protrusions 66b.

1. An input apparatus having a light pen anti-slip mechanism, comprising:
a display unit having a surface panel and a plurality of light-emitting portions; and
a plurality of anti-slip members for the tip of a light pen disposed on the surface panel, the anti-slip members being arranged so as to correspond to the respective light-emitting portions.

2. The input apparatus according to claim 1, wherein the anti-slip members are formed on the surface panel by elastomeric printing and are transparent.

3. An input apparatus having a light pen anti-slip mechanism, comprising:
a display unit having a surface panel and a plurality of light-emitting portions; and
a plurality of protrusions for the tip of a light pen disposed on the surface panel, the protrusions being arranged so as to correspond to the respective light-emitting portions.

4. The input apparatus according to claim 3, wherein the protrusions are integrally formed on the surface panel by injection molding or pressing.

5. The input apparatus according to claim 3, wherein the protrusions are integrally formed on the surface panel to have a spherical shape by dropping a potting compound containing an adhesive resin material onto the surface panel.

6. An input apparatus having a light pen anti-slip mechanism, comprising:
a display unit having a surface panel and a plurality of light-emitting portions; and
a plurality of depressions for the tip of a light pen disposed on the surface panel, the depressions being arranged so as to correspond to the respective light-emitting portions.

7. An input apparatus having a light pen anti-slip mechanism, comprising:
a display unit having a surface panel and a plurality of light-emitting portions; and
a lattice of ribs for the tip of the light pen disposed on the surface panel, the ribs being arranged so as to surround regions that correspond to the respective light-emitting portions.

8. The input apparatus according to claim 7, wherein the ribs are integrally formed on the surface panel to have a semicircular cross-section by injection molding or pressing.

9. The input apparatus according to claim 7, wherein the ribs are integrally formed on the surface panel to have a semicircular cross-section by dropping a potting compound containing an adhesive resin material onto the surface panel.

10. An input apparatus having a light pen anti-slip mechanism, comprising:
a display unit having a surface panel and a plurality of light-emitting portions; and
a plurality of stripe-shaped ribs for the tip of the light pen disposed on the surface panel, the ribs being arranged between the light-emitting portions so that the ribs are placed along the placements of the respective light-emitting portions.

11. The input apparatus according to claim 10, wherein the ribs are integrally formed on the surface panel to have a semicircular cross-section by injection molding or pressing.

12. The input apparatus according to claim 10, wherein the ribs are integrally formed on the surface panel to have a semicircular cross-section by dropping a potting compound containing an adhesive resin material onto the surface panel.

13. An input apparatus having a light pen anti-slip mechanism, comprising:
a display unit having a surface panel, an additional panel, and a plurality of light-emitting portions,
wherein the additional panel has a plurality of through holes for the tip of a light pen, the through holes being overlaid on the surface panel and being arranged so as to correspond to the respective light-emitting portions.
